(19) United States
(12) Patent Application Publication
(10) Pub. No.: US 2007/0166576 A1
(43) Pub. Date: Jul. 19, 2007

(54) Fuel cell power generation control methodology and the applications thereof

(76) Inventors: Chun-Chin Tung, Taipei (TW); Feng-Yi Deng, Taipei (TW); Yu-Chin Wang, Taipei (TW); Yu-Lin Tang, Taipei (TW)

Correspondence Address: G. LINK CO. LTD., 3550 BELL ROAD, MINOOKA, IL, 60447, US

(21) Appl. No.: 11/331,150

(22) Filed: Jan. 13, 2006

(51) Int. Cl. H01M 8/04

(52) U.S. Cl. 429/13; 429/23

(57) ABSTRACT

This invention comprises a fuel cell power generation control methodology and the applications thereof, comprising the step of providing a DC converter and a fuel cell and then electrically connecting an input side of the DC converter to an output side of the fuel cell; converting output electricity of the fuel cell of the DC converter into a constant voltage output; the DC converter converts the output current of the fuel cell into a constant voltage (CV); and the DC converter keeps the DC converter input side within the planned limit of a constant current (CC). In other words, the output current of the fuel cell is kept within the planned limit of a constant current, wherein the planned limit of the constant current (CC) is the current limit determined by the quantity of MEAs in the fuel cell and the current limit below the optimum power interval generated by the MEA. In addition, the present invention can also be applied in fuel cells, and together with other power output devices, provide multi-energy output.

### FIELD OF THE INVENTION

The present invention relates to a fuel cell power generation control methodology and the applications thereof, particularly to a fuel cell power generation control methodology, wherein a current value of an input side of a DC converter is controlled by the DC converter to keep it within a constant current limit, so that the fuel cell operates below or at maximum power output or optimum efficiency output, and can supply electricity at energy-saving status together with other electric power output devices.

### BACKGROUND OF THE INVENTION

Conventional DC converters, for example, conventional DC converters for use in secondary batteries, generally only need to consider the stability design of constant voltage output, and their output current can change with the load, and need not concern the effects of the voltage of electric power generated by secondary batteries on conventional DC converters. In addition, as secondary batteries are energy capacitors for storing energy after recharging, so that when using it, energy is released because of electricity discharge, and if the electric current is sufficient when secondary batteries are discharging electricity, the output current of secondary batteries can be kept at a constant current. Therefore, under sufficient electricity, secondary batteries can be considered constant voltage elements. However, fuel cells are energy converters, and do not store energy in advance. Therefore, if fuel cells are used together with conventional DC converters, and because the current value of the electricity generated by fuel cells will be subjected to great changes due to external load, conventional DC converters still convert energy based on the input current after fuel cells have been changed. Although conventional DC converts can still supply the power required by the load, the fuel cells do not necessarily operate at optimum power output.

In addition, an electronic system that uses fuel cells generally also uses other electric power output devices, for example, rechargeable secondary lithium batteries. Especially in a portable electronic system, it is not possible to know when the electricity of secondary batteries can be supplied, and the life of secondary batteries will be shortened due to frequency recharges. However, the fuel of fuel cells can be refilled at any time. Therefore, it is necessary to lower the electric power output of secondary batteries as far as possible, and electric power output supply achieves energy conservation of secondary batteries, primarily based on fuel cells.

In view of the foregoing weakness of conventional DC converters in providing the operational model for the optimum power output status of the fuel cell, the present inventor has come up with an improved fuel cell power generation control methodology, so that fuel cells continue to operate at optimum power output, and this control methodology is then applied in a multi-energy supply system that combines fuel cells and other electric power output devices.

### SUMMARY OF THE INVENTION

It is a primary objective of this invention to provide a fuel cell power generation control methodology and the applications thereof, so that DC converters keep output current at a constant current, and fuel cells continue to operate at optimum power output.

To achieve the above objective, the present invention provides a fuel cell power generation control methodology and the applications thereof, comprising the following steps: providing DC converters and fuel cells, and electrically connecting an input side of DC converters to an output side of fuel cells; converting the output electricity of fuel cells into a constant voltage output by means of DC converters; so that DC converters keep the input side of DC converters within the planned limit of a constant current. In other words, even if the output current of fuel cells are kept within a planned limit of a constant current, a current limit value is set for the planned limit of the constant current according to the quantity of membrane electrode assembly (MEAs) of the fuel cell and the current limit generated at optimum power interval of MEA, wherein the optimum power interval refers to any status of maximum electric power output and maximum power output of MEA that can be generated by the MEA at unit fuel consumption.

The present invention can also be applied in fuel cells, and together with other electric power output devices, provide multi-energy output.

### BRIEF DESCRIPTION OF THE DRAWINGS

The above objects and advantages of the present invention will become more apparent with reference to the appended drawings wherein:

FIG. 1 is a schematic view of a load circuit connection in the fuel cell power generation control methodology and the applications thereof in the present invention;

FIG. 2 is a current-power characteristics curve of a single MEA in a fuel cell used in the fuel cell power generation control methodology and the applications thereof in the present invention;

FIG. 3 is a flow chart of fuel cell power generation control methodology and the applications thereof in the present invention.

### DETAILED DESCRIPTION OF THE INVENTION

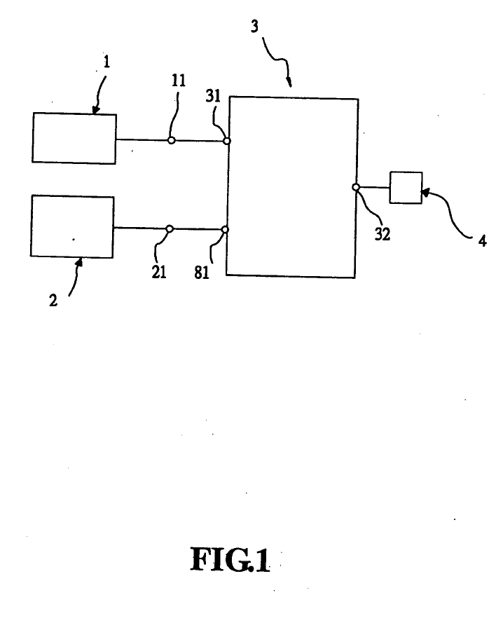

FIG. 1 shows a schematic view of a load circuit connection in the fuel cell power generation control methodology and the applications thereof in the present invention. Referring to FIG. 1, at least one fuel cell (1) and at least one secondary battery (2) of the present invention are connected to a DC converter (3) respectively, for converting voltage of the electricity outputted by the fuel cell (1) and the secondary battery (2), and then the DC converter (3) is connected to a load (4) to supply electricity load (4) after converting voltage of the DC converter (3), wherein the fuel cell (1) is an energy converter that generates electricity outputted by electrochemical reactions of hydrogen-rich fuel (such as methanol fuel), oxygen fuel, and catalysts. Said fuel cell (1) comprises a fuel cell output side (11) to output electricity generated by the fuel cell (1); a secondary battery (2) is another electricity generation device, which is a primary battery or a secondary battery that can convert stored chemical energy into electrical energy, and comprises a secondary battery output side (21) to output electricity generated by the secondary battery (1). For example, the secondary battery (2) can be a primary alkaline battery or a secondary lithium battery; the DC converter (3) comprises a plurality of DC converter input sides (31) corresponding to the fuel cell (1) and the secondary battery (2), and DC converter output sides (32) corresponding to the load (4). In addition, the DC converter (3) can convert electricity outputted by the fuel cell (1) or the secondary battery (2) to form the corresponding voltage, through buck logic or boost logic, for the voltage required for the load (4), which can be an electronic element or electronic system, which can execute the operation of the load (4), based on the electricity of stable voltage output by the DC converter (3).

The fuel cell output side (11) of the fuel cell (1) is electrically connected to a DC converter input side (31) of the DC converter (3) and the secondary battery output side (21) of the secondary battery (2) is electrically connected to another DC converter input side (31) of the DC converter (3), so that electricity generated by the fuel cell (1) and the secondary battery (2) is transmitted to the DC converter (3). In addition, the DC converter output side (32) of the DC converter (3) is electrically connected to the load (4) to transmit electricity at a specific voltage to the load (4).

The fuel cell (1) is a fuel cell made by the manufacturing process of a printed circuit board.

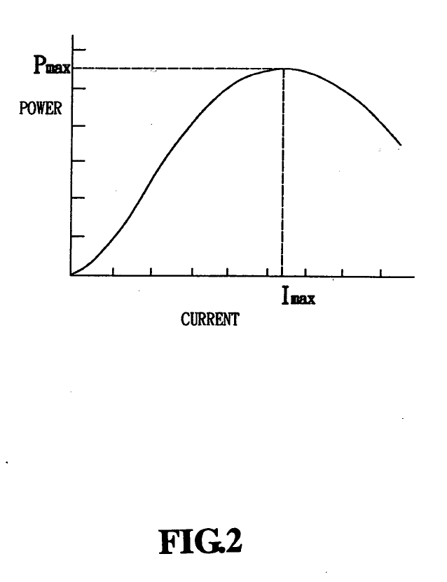

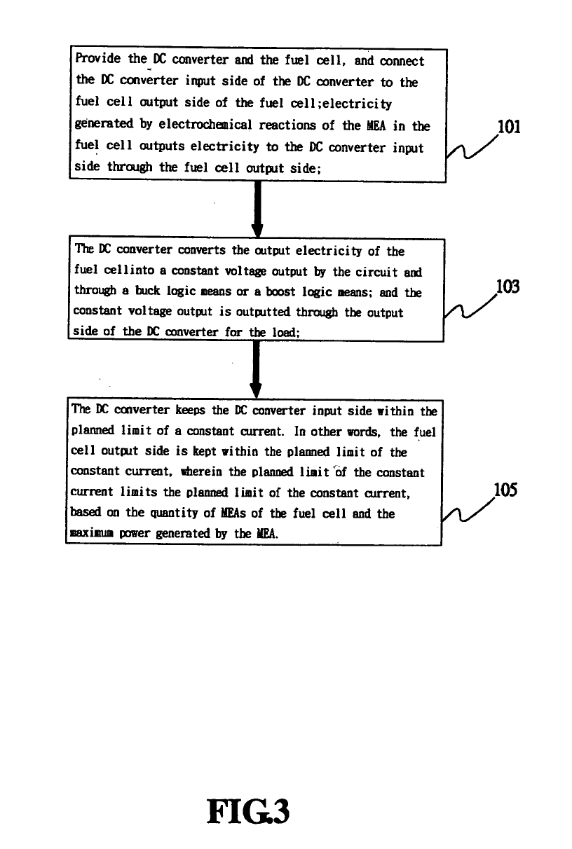

FIG. 2 is a current-power characteristics curve of single MEA of fuel cells used in the fuel cell power generation control methodology and the applications thereof in the present invention, and FIG. 3 is a flow chart of fuel cell power generation control methodology and the applications thereof in the present invention. Referring to FIG. 1, the DC converter (3) provided by the control methodology of the present invention comprises the functions provided by the constant voltage output to the load (4) and is also capable of continuously keeping the current value of the DC converter input side (31) within a constant current limit, and generating this corresponding current value through buck logic or boost logic, at a specific power and an operating voltage of the load (4). In addition, the DC converter (3) comprises the maximum current output value of the fuel cell (1) that limits operations. Referring further to FIG. 2, the current output value of each MEA of the fuel cell (1) will correspond to a power output value, wherein when each MEA of the fuel cell (1) generates a maximum current value (Imax), this will correspondingly generate a maximum output power (Pmax), and the maximum current output value (Imax) of the DC converter (3) that limits fuel cell (1) operations is kept below or equal to Imax of the maximum power output (Pmax.) In other words, the fuel cell (1) operates below or equal to Pmax, wherein the control methodology of the present invention comprises a step (101), a step (103), and a step (105), which are described respectively as follows: Referring to FIG. 1 and FIG. 3, the step (101) provides the DC converter (3) and the fuel cell (1), and then connects the DC converter input side (31) of the DC converter (3) to the fuel cell output side (11) of the fuel cell (1), so that the electricity generated by electrochemical reactions of the MEA in the fuel cell (1) outputs electricity to the DC converter input side (31) through the fuel cell output side (11).

The step (103) is to convert the output electricity of the DC converter (3) by the fuel cell (1) into a constant voltage output. The DC converter (3) converts the electricity generated by the fuel cell (1) through buck logic or boost logic, by circuit into constant voltage output, which is then outputted by the DC converter output side (32) for the load (4.) Of course, the constant voltage output of the DC converter (3) is not limited to the output of a constant voltage, and based on the actual needs of the load, the DC converter (3) can also be converted into a different constant voltage output.

The Step (105) is a process in which the DC converter (3) keeps the DC converter input side (31) within the planned limit of a constant current. In other words, the fuel cell output side (11) is kept within the planned limit of the constant current, wherein the planned limit of the constant current is determined by the quantity of MEAs in the fuel cell (1) and the Imax below the maximum power interval generated by the MEA.

According to the above-mentioned steps, the DC converter (3) decides if the magnitude of the current or power required by the load (4) is greater than the Imax or the Pmax corresponding to the fuel cell (1). If the magnitude of the current or power required by the load (4) is smaller than or equal to the Imax or the Pmax corresponding to the fuel cell (1), the electricity outputted by the fuel cell (1) is sufficient to supply the required load (4); if the magnitude of the current or power required by the load (4) is greater than the Imax or the Pmax corresponding to the fuel cell (1), then the electricity outputted by the fuel cell (1) is not sufficient to supply the required load (4).

According to the above-mentioned steps, when the current value outputted by the fuel cell (1) is kept below or equal to Imax, and the electricity outputted by the fuel cell (1) is sufficient to supply the required load (4), the DC converter (3) selects to terminate the status of electricity supplied by the secondary battery (2). In addition, the DC converter (3) will convert the electricity outputted by the fuel cell (1) into a stable voltage and current, which are then supplied to the electricity required by the load (4) through the DC converter output side (32).

According to the above-mentioned steps, when the current value output by the fuel cell (1) is kept below or equal to Imax, and the electricity outputted by the fuel cell (1) is not sufficient to supply the required load (4), the DC converter (3) selects to terminate the status of electricity [0] supplied by the secondary battery (2). In addition, the DC converter (3) will convert the electricity outputted by the fuel cell (1) and the secondary battery (2) into a stable voltage and current, which are then supplied to the electricity required by the load (4) through the DC converter output side (32).

In addition, according to the above-mentioned steps, the power value outputted by the fuel cell (1) can be used to decide if the secondary battery (2) supplies electricity or not. In other words, when the power value outputted by the fuel cell (1) is kept smaller or equal to Pmax, and the electricity outputted by the fuel cell (1) is sufficient to supply the required load (4), the DC converter (3) selects to terminate the status of electricity supplied by the secondary battery (2). In addition, the DC converter (3) will convert electricity outputted by the fuel cell (1) into a stable voltage and current, which are then supplied to the electricity required by the load (4) through the DC converter output side (32). Furthermore, when the power value output by the fuel cell (1) is kept smaller or equal to Pmax, and the electricity outputted by the fuel cell (1) is not sufficient to supply the required load (4), the DC converter (3) selects the status of electricity supplied by parallel connection of the secondary battery (2) and the fuel cell (1). In addition, the DC converter (3) will convert electricity outputted by the fuel cell (1) and the secondary battery (2) into a stable voltage and current, which are then supplied to the electricity required by the load (4) through the DC converter output side (32).

According to the above-mentioned steps, when the fuel cell (1) is sufficient to independently supply electricity required by load (4), the DC converter (3) can select to terminate the electricity supplied by the secondary battery (2) to the load (4), and select electricity supply of the fuel cell (1) to the secondary battery (2) for recharging the secondary battery (2).

According to the above-mentioned steps, the DC converter (3) keeps the DC converter input side (31) within the planned limit of a constant current. In other words, the fuel cell output side (11) is kept within the planned limit of a constant current, wherein the planned limit of the constant current limits the planned limit of the constant current, based on the quantity of MEAs of the fuel cell (1) and the power output of the optimum operating efficiency generated by a MEA, wherein the power output of the optimum operating efficiency generated by the MEA refers to the status of maximum electric power output generated by the MEA at unit fuel consumption.

It is to be understood that the foregoing description of the present invention should not be based to restrict the invention, and that all equivalent modifications and variations made without departing from the intent and import of the foregoing description should be included in the following claim.

What is claimed is:

1. A fuel cell power generation control methodology, comprising:
providing a DC converter and a fuel cell, and then connecting an input side of the DC converter to an output side of the fuel cell;
converting electricity output of the fuel cell by the DC converter into a constant voltage output; and
the DC converter keeps the DC converter input side within the planned limit of a constant current, wherein the planned limit of the constant current is the current limit based on the quantity of MEAs in the fuel cell and the maximum power generated by the MEA to limit the planned limit of the constant current.

2. The fuel cell power generation control methodology as claimed in claim 1, wherein the optimum power interval can be any status of the maximum electric power output and the maximum power output of the MEA generated by the MEA at unit fuel consumption.

3. The fuel cell power generation control methodology as claimed in claim 2, further comprising the following steps:
further providing a secondary battery and then connecting another side of the DC converter to the output side of the secondary battery;
keeping the current value outputted by the fuel cell below or equal to Imax, and the electricity outputted by the fuel cell sufficient to supply the required load, so that the DC converter selects to terminate the electricity status supplied by the secondary battery; and
keeping the current value outputted by the fuel cell below or equal to Imax, and the electricity outputted by the fuel cell not sufficient to supply the required load, so that the DC converter selects the parallel electricity power status of the secondary battery and the fuel cell.

4. The fuel cell power generation control methodology as claimed in claim 3, further comprising the following steps: when the fuel cell is sufficient to independently supply electricity required by load, the DC converter selects to terminate the continuous electricity supply of the secondary battery to the load, and selects electricity supply of the fuel cell to the secondary battery for recharging the secondary battery.

5. The fuel cell power generation control methodology as claimed in claim 1, wherein the fuel cell is a fuel cell made by the manufacturing process of printed circuit board.

6. The fuel cell power generation control methodology as claimed in claim 3, wherein the secondary battery can be a primary battery or a secondary battery.
